(19) United States
(12) Patent Application Publication
(10) Pub. No.: US 2009/0004907 A1
(43) Pub. Date: Jan. 1, 2009

(54) Connector converters for portable electronic device power adapters

(75) Inventors: Stuart O. Goldman, Scottsdale, AZ (US); Richard E. Krock, Naperville, IL (US); Karl F. Rauscher, Murray Hill, NJ (US); James P. Runyon, Wheaton, IL (US)

Correspondence Address: FAY SHARPE/LUCENT, 1100 SUPERIOR AVE, SEVENTH FLOOR, CLEVELAND, OH, 44114, US

(73) Assignee: Lucent Technologies Inc.

(21) Appl. No.: 11/819,352

(22) Filed: Jun. 26, 2007

(51) Int. Cl. H01R 4/24

(52) U.S. Cl. 439/387

(57) ABSTRACT

A system is provided for selectively connecting a plurality of diverse power adapters (12) to a specific portable electronic device (10). The system including: a set of connector converters (30), each connector converter (30) having a first end (32) which is configured the same as the first end (32) of every other connector converter (30) in the set; and a second end (34) opposite the first end (32), wherein the second end (34) is configured differently from the second end (34) of every other connector converter (30) in the set.

### FIELD

The present inventive subject matter relates to the art portable electronic devices. Particular application is found in connection with personal computers, such as, laptop computers, notebook computers, tablet computers, etc., and the specification makes particular reference thereto. However, it is to be appreciated that aspects of the present inventive subject matter are also amenable to other like portable electronic devices and/or applications.

### BACKGROUND

Portable personal computers (PCs) can be found in wide variety of different makes and/or models that are readily available from a substantial array of different manufactures. For example, these portable PCs are commonly referred to as laptop PCs, notebook PCs or tablet PCs (i.e., laptops, notebooks or tablets, for short). Nevertheless, in the interest of clarity and simplicity, these terms are used interchangeably herein. Moreover, wherever the terms are used herein, the meaning is intended to encompass all such similar portable PCs.

Laptop PCs generally operate on electrical power, as is well understood in the art. To enhance portability, laptops are typically equipped with one or more rechargeable batteries that provide electrical power thereto. Commonly, a laptop battery is designed and/or manufactured to meet specific physical and electrically constraints, parameters and/or characteristics dictated by the particular make and/or model of laptop for which the battery is intended. Accordingly, laptop batteries are not generally interchangeable between different laptop makes and/or models.

Additionally, with reference now to FIG. 1, a conventional laptop PC 10 is usually supplied with a detachable power cord or power adapter 12. The power adapter 12 allows, e.g., line or mains power from a conventional source, such as a wall outlet or other socket, to be routed to the laptop 10 to recharge the batteries and/or otherwise power the laptop 10. A typical power adapter for a laptop (such as the illustrated power adapter 12) generally includes one or more lengths of insulated electrical cord 14 and a power converter 16. Commonly, a conventional plug 18 is provided at one end of the cord 14 for connecting the power adapter 12 to a conventional source of electrical power, e.g., line or mains power. Generally, the plug 18 is configured to fit a conventional electrical outlet or socket. For example, in North America, the plug 18 typically conforms to the NEMA (National Electrical Manufactures Association) specifications for 1-15 or 5-15 type plugs.

The power converter 16 converts the supplied electrical power from the source into a type suitable for the laptop 10. That is to say, the laptop 10 generally prescribes specific parameters (e.g., form, voltage and/or current characteristic) for the electrical power on which it operates, and the power converter 16 converts the supplied electrical power to meet these parameters. Commonly, the power adapter 12 is an AC/DC (alternating current/direct current) adapter, in which supplied AC power is converted by the power converter 16 into DC power at the specified voltage and/or current employed by the laptop 10. In the illustrated example, the power converter 16 is arranged toward a middle of the cord 14, however, in other typical examples the plug 18 and the power converter 16 are integrated with one another. In any event, often different parameters for the electrical power (i.e., different forms, different voltages and/or different current characteristics) are prescribed to suitably power different makes and/or models of laptops. For example, the prescribed operating voltage across an array of different commonly available makes and/or models of laptop PCs can vary from 11.5 volts (V) to 16 V.

Typically, at the other end of the cord 14 (i.e., the end opposite the plug 18), the power adapter 12 is provided with a connector 20 that is configured to mated with and/or fit a corresponding power port 22 on the laptop 10. The connector 20 is usually a male fitting or plug designed and/or manufactured to conform to the particular physical constrains (i.e., size, dimensions, shape, etc.) of the power port 22, which is usually a female fitting or socket. Generally, the connector and power port vary between different makes and/or models of laptops. That is to say, the physical characteristics (e.g., shape, size, dimensions, etc.) of the connector 20 and port 22 do not typically conform to a recognized standard, rather they vary from laptop to laptop, e.g., depending upon the make and/or model of the laptop.

As can be appreciated, the conventional laptop PC 10 is generally inoperative without the appropriate electrical power. Accordingly, a problem can be encounter when the laptop's battery has been depleted or is exhausted and the corresponding power adapter 12 has been damaged, misplaced, forgotten or is otherwise unavailable. Moreover, the use of an alternate power adapter (e.g., borrowed from a different make and/or model of laptop) is often not an option—(i) because inconsistencies in the physical characteristics of the connector provided on the alternate power adapter and the power port 22 would prohibit the alternate power adapter from being plugged into the laptop 10, and/or (ii) because the power converter of the alternate power adapter may not provide electrical power with the appropriate characteristics to support proper operation of the laptop 10.

Accordingly, a new and improved device and/or method for promoting interoperability between otherwise incompatible power adapters and portable electronic devices is provided that overcomes the above-referenced problems and others.

### SUMMARY

In accordance with one embodiment, a system is provided for selectively connecting a plurality of diverse power adapters to a specific portable electronic device. The system including: a set of connector converters, each connector converter having a first end which is configured the same as the first end of every other connector converter in the set; and a second end opposite the first end, wherein the second end is configured differently from the second end of every other connector converter in the set.

In accordance with another embodiment, a set of connector converters is provided for selectively mating a plurality of diverse power adapters to a specifically configured power port on a laptop computer. Each connector converter in the set includes: a first end which is configured the same as the first end of every other connector converter in the set; and, a second end opposite the first end, the second end being configured differently from the second end of every other connector converter in the set.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagrammatic illustration of a conventional laptop PC and corresponding power adapter exemplifying the prior art.

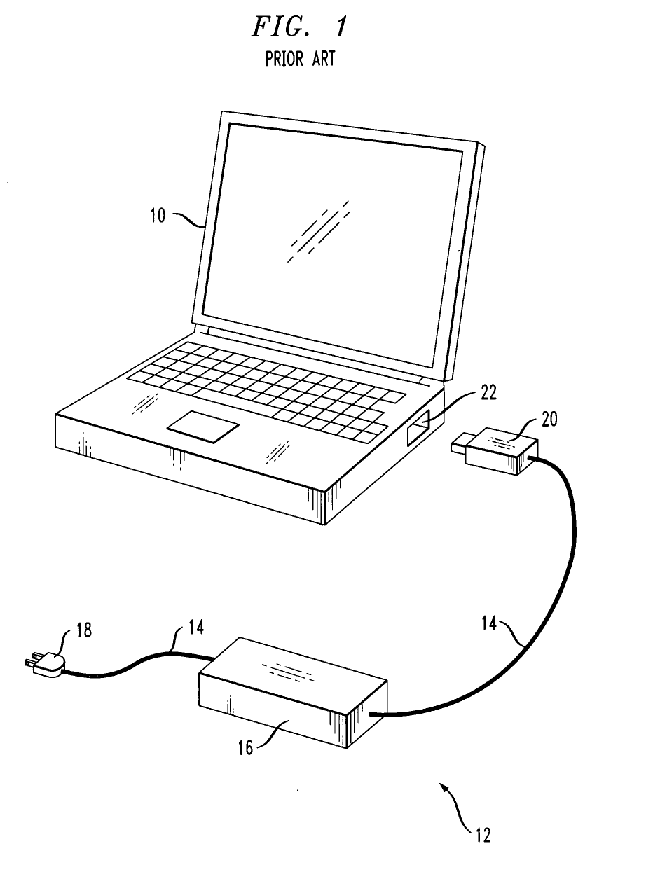

FIG. 2 is a diagrammatic illustration showing a set of connector converters suitable for practicing aspects of the present inventive subject matter.

FIG. 3 is a diagrammatic illustration showing a first end of one of the connector converters illustrated in FIG. 2 and an optional resistor.

### DETAILED DESCRIPTION OF PREFERRED EMBODIMENTS

For clarity and simplicity, the present specification shall refer to structural and/or functional elements, relevant standards and/or protocols, and other components that are commonly known in the art without further detailed explanation as to their configuration or operation except to the extent they have been modified or altered in accordance with and/or to accommodate the preferred embodiment(s) presented herein.

Generally, the present specification discloses a set of connector converters that are operative to provide compatibility between a particular portable electronic device and various different power adapters that would otherwise be incompatible with the particular portable electronic device, e.g., because the various different power adapters were originally designed, manufactured and/or otherwise intended for use with other portable electronic devices—that is, other portable electronic devices different from the particular portable electronic device for which the set of connector converters are intended. For example, the set of connector converters are suitably designed and/or manufactured to be used with a specific laptop PC, e.g., a particular make and/or model of laptop PC. The connector converters, accordingly, each have one end (i.e., a first end) that is configured to suitably mate with and/or fit the specific power port on the particular laptop for which the set of connector converters is intended. That is to say, the first end of one connector converter in the set is configured the same as the first end of every other connector converter in the set—this common configuration suitably conforms to and/or otherwise meets the physical constraints and/or characteristics (e.g., size, dimensions, shape, etc.) of the power port on the laptop PC for which the set of connector converters is intended.

The other ends (i.e., the second ends) of the connector converters are configured differently from one another so as to mate with and/or fit a plurality of different connectors provided on the ends of a plurality of different power adapters. More specifically, the second end of each connector converter in the set is suitably configured to conform to and/or otherwise meet the specific physical constraints and/or characteristics (e.g., size, dimensions, shape, etc.) of the particular connector provided on the end of the specific power adapter with which the individual connector converter is to be used. Accordingly, the set of connector converters collectively allow a plurality of different power adapters (e.g., designed and/or manufactured for various other makes and/or models of laptops) to be used with the particular make and/or model of laptop for which the connector converters are intended.

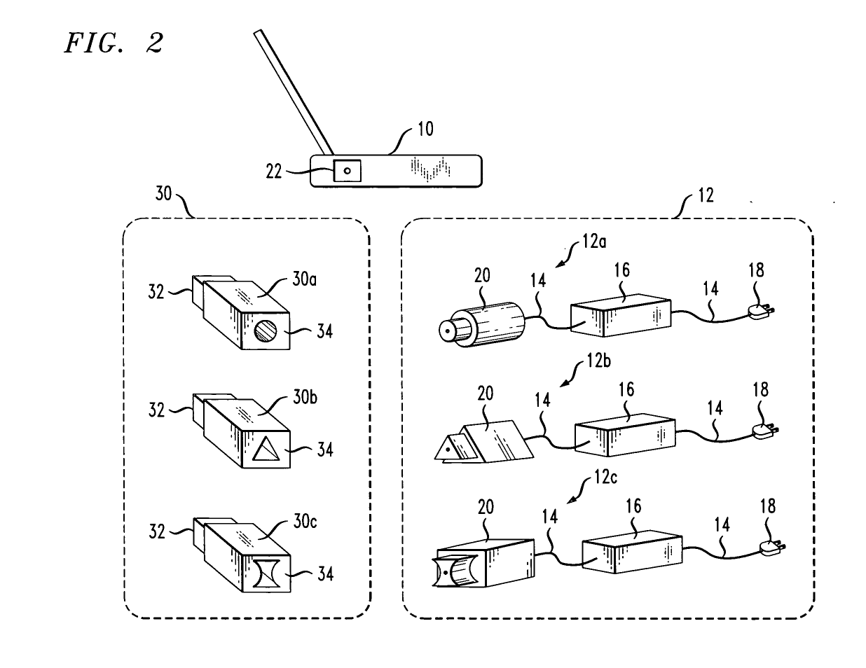

With reference now to the FIGURES, where like elements are indicated by like reference numerals, FIG. 2 illustrates:
a particular conventional laptop PC 10 including a specific power port 22 configured to receive and/or otherwise mate with a specific connector (e.g., a connector provided on an end of a power adaptor (not illustrated) which is initially supplied or otherwise intended to be used with the particular make and/or model of laptop 10); and,
a set of connector converters (generally indicated by reference numeral 30, and individually indicated by reference numerals 30a, 30b and 30c) that are intended for use with the laptop 10.
   Also shown in FIG. 2 are various different conventional power adapters (generally indicated by reference numeral 12, and individually indicated by reference numerals 12a, 12b and 12c). While only three connector converters 30 and three power adapters 12 are illustrated, in practice more or less than three connector converters 30 are optionally included in the set to accommodate a greater or lesser variety of different power adapters 12.

Suitably, as described above in the background, the different power adapters 12 each include: one or more lengths of insulated electrical cord 14; a power converter 16; and, a plug 18 arranged and/or otherwise provided at one end of the cord 14. As illustrated, the different power adapters 12 also include different connectors 20 arranged and/or otherwise provided at the respective ends of the cords 14 opposite the plugs 18. More specifically, each of the connectors 20 is configured differently from the others, i.e., each connector 20 has different physical characteristics, e.g., size, dimensions, shape, etc. For example, each connector 20 is configured to mate with and/or fit the specific physical constraints of a different power port such as is typically found on different makes and/or models of laptops.

In any event, suitably, none of the connectors 20 mate with or fit the power port 22. That is to say, none of the connectors 20 conform to the physical constraints (e.g., size, dimensions, shape, etc.) of the power port 22. Therefore, absent the connector converters 30, the power adapters 12 could not be used with the laptop 10 insomuch as the connectors 20 could not be plugged into the power port 22.

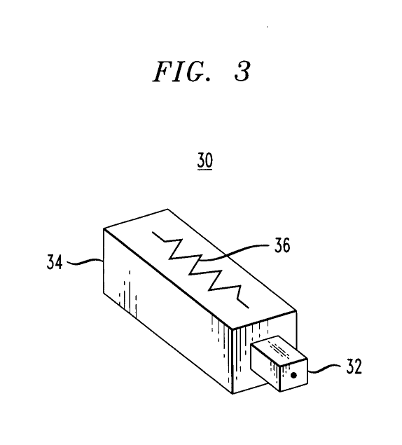

In the illustrated embodiment, the set of connector converters 30 are suitably designed and/or manufactured to be used with the specific laptop PC 10, i.e., a particular laptop make and/or model. The connector converters, accordingly, each have a commonly configured first end 32 (e.g., better seen in FIG. 3) that is formed to suitably mate with and/or fit the specific power port 22 on the laptop 10. That is to say, suitably, the first end 32 of one connector converter 30 is configured the same as the first end of every other connector converter 30 in the set—this common configuration in turn conforms to and/or otherwise meets the physical constraints and/or characteristics (e.g., size, dimensions, shape, etc.) of the power port 22 on the laptop PC 10 for which the set of connector converters 30 is intended.

The second ends 34 of the connector converters 30—opposite the first ends 32—are configured differently from one another so as to mate with and/or fit the plurality of different connectors 20 provided on the ends of the plurality of different power adapters 12. More specifically, the second end 34 of each connector converter 30 is suitably configured to conform to and/or otherwise meet the specific physical constraints and/or characteristics (e.g., size, dimensions, shape, etc.) of the particular connector 20 provided on the end of the specific power adapter 12 with which the individual connector converter 30 is to be used. For example, the second end 34 of the individual connector converter 30a suitably mates with the connector 20 provided on the end of power adapter 12a, while the second end 34 of the individual connector converter 30b suitably mates with the connector 20 provided on the end of power adapter 12b, and the second end 34 of the individual connector converter 30c suitably mates with the connector 20 provided on the end of power adapter 12c.

Accordingly, the set of connector converters 30 collectively allow the plurality of different power adapters 12 to be connected and/or otherwise used with the particular make and/or model of laptop 10 for which the set of connector converters 30 are intended. Therefore, if the original power adapter supplied with and/or otherwise indented for the laptop 10 is lost, damaged, forgotten or otherwise unavailable, a user may, e.g., obtain electrical power for the laptop 10 by borrowing a power adapter from another laptop, even if that laptop is of a different make and/or model or otherwise employs a differently configured power port.

Nevertheless, as can be appreciated, the prescribed electrical power suitable for effectively operating the laptop 10 may not be met by the power converter of every different type of power adapter. For example, the laptop 10 may operate on 16 V DC power, but a given power adapter may only supply 11.5 V DC power. In this case, the foregoing power adaptor would not be suitable for the laptop 10 even if an appropriate connector converter were available.

Therefore, to guard against connecting or using a power adapter that would supply inappropriate power to the laptop 10, the set of connector converts 30 preferably only includes those individual connector converts 30 that support connection compatibility with power adapters that supply electrical power which is compatible with operation of the laptop 10. Additionally, a compatibility table or other like reference chart is provided with the set of connection converters to permit a user to readily identify which power adapters supply power that is compatible with the laptop 10 and which connector converter 30 should be used each particular power adapter. Table 1 shows an example of such as chart.

TABLE 1
Example Compatibility Chart

| Connector | Power |
|---|---|
| Converter ID | Adapter |
| A | Dell - D820 |
| B | Gateway - C-120X |
| . | . |
| . | . |
| . | . |
| n | Apple - MacBook |

Suitably, as shown in Table 1, the chart identifies each connection converter 30 by a unique ID (e.g., such as a letter or number or other distinguishing ID). Likewise, the corresponding IDs are also imprinted or otherwise provided on the actual connection converters 30. Additionally, the identity of the power adapters which provide compatible power are also listed in the chart, e.g., next to the connection converter ID which identifies the individual connection converter 30 that mates with or otherwise fits the connector 20 of the particular power adapter 12. For example, in the chart, the power adapters are optionally identified by the particular make and/or model of laptop for which they were originally designed and/or manufactured. In this manner, a user can readily identify the makes and/or models of laptops from which power adapters can be borrowed. Alternately, the power adapters can be identified by their own make and/or models numbers.

Optionally, as illustrated in FIG. 3, one or more of the connection converters 30 is equipped or provisioned with an appropriate resistor 36 or other suitable electrical components for reducing the voltage and/or corresponding current supplied by the power adapter 12 for which the individual connection converter 30 is intended. For example, the power adapter 12a may be configured with a power converter 16 that supplies 16 V power—however, the laptop 10 may operate on only 11.5 V power. In this instance, even though the connection converter 30a would permit the power adapter to be connected to the laptop 10, the excessive voltage supplied by the power adapter 12a could potentially damage the laptop 10. Accordingly, in this case, the connection converter 30a is equipped or provisioned with an appropriate resistor 36 or other suitable electrical components for reducing the voltage and/or corresponding current supplied by the power adapter 12a to the appropriate levels for the laptop 10. Similarly, the other connection converters 30 are also suitably equipped or provisioned where appropriate with resistors 36 or other suitable electrical components for reducing the voltage and/or associated current supplied by their corresponding power adapters 12.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A system for selectively connecting a plurality of diverse power adapters to a specific portable electronic device, said system comprising:
a set of connector converters, each connector converter including;
a first end which is configured the same as the first end of every other connector converter in the set; and,
a second end opposite the first end, said second end being configured differently from the second end of every other connector converter in the set.

2. The system of claim 1, wherein the first ends of the connector converters are configured to mate with a port on said specific portable electronic device.

3. The system of claim 2, wherein the plurality of diverse power adapters are provided with differently configured connectors, and the second end of each connector converter is configured to mate with a particular connector provided at the end of at least one of the plurality of diverse power adapters.

4. The system of claim 3, wherein the connectors provided at the ends of the plurality of diverse power adapters do not fit the power port.

5. The system of claim 4, wherein the portable electronic device is a laptop computer.

6. The system of claim 5, further comprising:
a chart listing the power adapters that provide electrical power compatible with operation of the laptop computer.

7. A set of connector converters for selectively mating a plurality of diverse power adapters to a specifically configured power port on a laptop computer, wherein each connector converter in the set comprises:
a first end which is configured the same as the first end of every other connector converter in the set; and,
a second end opposite the first end, said second end being configured differently from the second end of every other connector converter in the set.

8. The set of connector converters of claim 7, wherein the first ends of the connector converters are configured to mate with the power port on the laptop computer.

9. The set of connector converters of claim 8, wherein the plurality of diverse power adapters are provided with differently configured connectors, and the second end of each connector converter is configured to mate with a particular connector provided at the end of at least one of the plurality of diverse power adapters.

10. The set of connector converters of claim 9, wherein the connectors provided at the ends of the plurality of diverse power adapters do not fit the power port.

11. The set of connector converters of claim 7, wherein at least one of the connection converters is provisioned with a voltage or current reducing electrical component for reducing a voltage or current supplied by the associated power adapter to a level suitable for operation of the laptop computer.

12. The set of connector converters of claim 11, wherein the electrical component is a resistor.
